(19) United States
(12) Patent Application Publication
(10) Pub. No.: US 2008/0310028 A1
(43) Pub. Date: Dec. 18, 2008

(54) NEAR FIELD LENS FOR A LIGHT ASSEMBLY

(76) Inventors: Jeyachandrabose Chinniah, Belleville, MI (US); Edwin Mitchell Sayers, Saline, MI (US); Jeff C. Lin, Novi, MI (US); Christopher L. Eichelberger, Livonia, MI (US)

Correspondence Address: VISTEON/BRINKS HOFER GILSON & LIONE, 524 South Main Street, Suite 200, Ann Arbor, MI, 48104, US

(21) Appl. No.: 11/764,779

(22) Filed: Jun. 18, 2007

(51) Int. Cl. G02B 17/00

(52) U.S. Cl. 359/642

(57) ABSTRACT

The present invention provides a near field lens for an automotive light assembly. The lens comprises a main body having a radial collimating portion formed as a rotation about a central axis. A light-collecting faces defines pocket in the main body and receives light from the light source. The radial collimating portion is structured to radially direct light in planes normal to the central axis and to collimate light in radial planes through the central axis. By extending the main body, a thin plate near field lens is provided.

### BACKGROUND OF THE INVENTION

1. Field of the Invention

The present invention relates generally to lens assemblies for light assemblies, and more particularly relates to near field lens assemblies structured for use with a light source, such as a light emitting diode.

2. Background of the Invention

Light emitting diodes (LEDs) are fast becoming the preferred light source for automotive lighting applications, as they consume less power, but still provide light output level that is acceptable for such applications. Near field lenses (NFLs) are used to collect as well as to collimate the light from a LED source. NFLs typically provide high light collection efficiency (approximately 70-90 percent).

In the automotive field, lighting assemblies not only provide a functional aspect, but also contribute to both the aesthetic appearance and brand signature differentiation between various vehicle lines. Some of the new vehicle designs demand more versatile and/or complex packaging space requirements for corresponding lamp assemblies. For example, high aspect ratio openings, such as long narrow rectangular openings for signal lamps, are currently being proposed. Such packaging requirements for vehicle lamps increase the design complexity of the standard optical elements. Although standard NFLs are efficient light collectors and collimators for LED light sources, they generally have narrowly round or square light exit areas and are thus not suitable for exit areas that are more complex and may require higher aspect ratios.

### BRIEF SUMMARY OF THE INVENTION

In one aspect, the present invention provides a near field lens for a light assembly that has a light source. The lens comprises a main body of light transmitting material. The main body includes a light-collecting face disposed generally opposite of a,light-emitting face. A side wall joins the light-collecting and light emitting faces. The light-collecting face defines a pocket that receives light from the light source and further includes a radial collimating surface and an axial surface. The radial collimating surface is structured to direct light radially outward from a central axis along a plurality of radial axes such that along each of the radial axes, light is collimated.

In another aspect, the present invention provides a light assembly for an automotive lighting application. The light assembly comprises a LED light source and a near field lens. The near field lens includes a main body of light transmitting material. The main body includes a radial collimating portion having a cross-sectional shape. Extending radially outward from a horizontal axis is the cross-sectional shape of the radial collimating portion. A structure of the radial collimating portion corresponds to a rotational extrusion of the cross-sectional shape about the horizontal axis. The near field lens further includes a pocket which is defined by the radial collimating portion. Light from the LED light source is received by the pocket. The radial collimating portion is structured to direct light radially outward from the horizontal axis along a plurality of radial axes such that along each of the radial axes light is collimated.

### BRIEF DESCRIPTION OF THE DRAWINGS

FIG. 1A is a cross-sectional view of a near field lens in accordance with the present invention;

FIG. 1B is an end view of the near field lens depicted in FIG. 1A;

FIG. 1C is a side view of the near field lens depicted in FIG. 1A;

FIG. 2A is a cross-sectional view of a near field lens in accordance with another embodiment of the present invention;

FIG. 2B is a side view of the near field lens depicted in FIG. 2A;

2C is a perspective view of the near field lens depicted in FIG. 2A;

FIG. 3A is an end view of a near field lens in accordance with another embodiment of the present invention;

FIG. 3B is a side view of the near field lens depicted in FIG. 3A;

FIG. 3C is a side view, similar to that of FIG. 3B, of another embodiment of a near field lens incorporating the principles of the present invention, where the central open area of the NFL is not enclosed;

FIG. 30 is a side view, similar to that of FIG. 3D, having stepped side walls partially defining the central open area of the NFL;

FIG. 4 is a side view of a near field lens in accordance with another embodiment of the present invention;

FIG. 5A is a sectional view of a near field lens in accordance with another embodiment of the present invention;

FIG. 5B is a perspective view of the near field lens depicted in FIG. 5A;

FIG. 6A is an end view of an arrangement of near field lenses in accordance with another embodiment of the present invention; and

FIG. 6B is a perspective view of the arrangement of near field lenses depicted in FIG. 6A.

Further objects, features and advantages of the invention will become apparent from consideration of the following description and appended claims when taken in connection with the accompanying drawings.

### DETAILED DESCRIPTION OF THE INVENTION

Detailed embodiments of the present invention are disclosed herein. It is understood however, that the disclosed embodiments are merely exemplary of the invention and that the invention may be embodied in various alternative forms. The figures are not necessarily to scale; some figures may be exaggerated or minimized to show the details of a particular component. Therefore, specific structural and functional details disclosed herein are not to be interpreted as limiting, but merely as a representative basis of the claims and for teaching one skilled in the art to practice the present invention.

The present invention seeks to overcome some of the concerns associated with using NFLs in lighting applications that demand more complex and/or higher aspect ratio light exit areas and related light distribution patterns.

Employing the principles of the present invention is an NFL that includes a radial collimating portion. The radial collimating portion radially directs light in one plane, which corresponds to a wide hemispherical light distribution, while collimating the light in generally a more narrow light distribution in another plane, transverse to the first plane. Thus, an NFL is provided having a relatively high aspect ratio. This light distribution, which is directed and/or redirected towards a light exit area of the NFL, may be further controlled, enhanced or manipulated to create a more complex and/or higher aspect ratio light distribution.

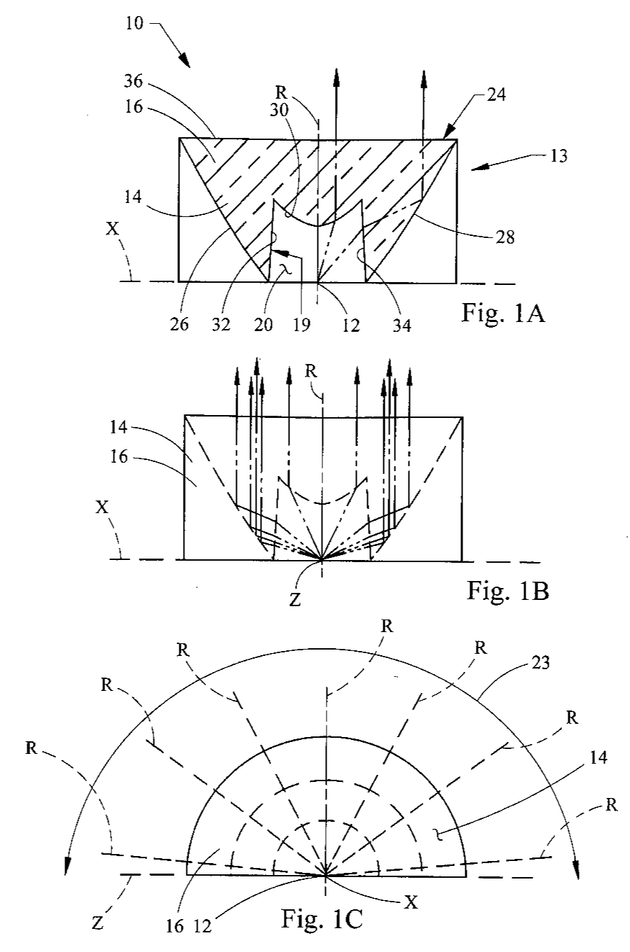

Referring now to the drawings, FIG. 1A depicts a cross-sectional view of an NFL light assembly embodying the principles of the present invention, which is generally designated at 10. While the NFL light assembly 10 is described in conjunction with requirements for automotive functions and/or applications, it will be recognized by those skilled in the art that the NFL light assembly 10 may be employed outside of the automotive field and in any field which employs LEDs or any other similar light source with similar performance criteria.

The NFL light assembly 10 generally includes a light source 12 and a NFL 13. Preferably, the light source is an LED. The LED radiates light with a specific spectral power distribution that may represent a color temperature. For example, the LED may radiate a blue, a blue-white or a white color temperature light. Moreover, the LED may radiate light spherically, hemispherically or some fractional portion thereof. Other suitable light sources known to those skilled in the art may also be used.

Referring to FIGS. 1A through 1C, the NFL 13 comprises a main body 14 made of a light transmitting material. The light transmitting material is preferably an optical grade of plastic and for example, amorphous plastics, such as polycarbonate (PC) or polymethylmethacralate (PMMA), may be used. Other suitable light transmitting materials may also be used.

The main body 14 includes a radial collimating portion 16 disposed about a central axis X. As seen in FIG. 1A, the radial collimating portion 16 has a cross-sectional shape 24 extending radially outward from the central axis X and the main body 14 is formed or defined as a surface of rotation about the central axis X. The rotation of the cross-sectional shape 24 about the central axis X to form the main body 14 preferably corresponds to a rotation of approximately 60 to 180 degrees. This may preferably provide a radial collimating portion 16 that is matched to a light source 12 having a corresponding fractional spherical distribution so that the NFL 13 substantially collects the radiated light, or loses only some partial light, between the light source 12 and the NFL 13, providing for certain functional and/or aesthetic effects.

A light collecting face 19 defines a pocket 20 in the radial collimating portion 16 that receives light from the light source 12. As such, the light source 12 is positioned on or proximate to the central axis X and in the pocket 20 opening.

The radial collimating portion 16 is configured to direct light radially outward from the central axis X along an infinite number of radial axes R, thereby defining a radial light distribution 23 transverse to the central axis X (See FIG. 1C). For example, light directed radially outward within a transverse plane, Z-R plane, to the horizontal axis 18 substantially corresponds to light distribution from a Lambertian light source, which provides substantially similar brightness or luminance when viewed radially at different angles. The structure of the radial collimating portion 16 is also such that within each radial plane, X-R plane,, the light is substantially collimated (See FIG. 1B).

The light collecting face 19 is further comprised of a radial surface 30 located between opposed inner axial surfaces 32, 34. The first and second axial surfaces 32, 34 generally extend outwardly from the horizontal axis 18. The radial surface 30 extends between the inner axial surfaces 32, 34. The radial surface 30 is curved, outwardly convex relative to the light source 20, so as to refract light such that along each X-R plane the light is collimated. The inner axial surfaces 32, 34 are shaped and positioned relative to light source 20 to respectively refract light towards outer axial surfaces 26, 28, which extend generally outward from the central axis X. Preferably, the first and second outer axial surfaces 26, 28 are free form surfaces that redirect light via the principles of total internal reflection such that along each X-R plane the light is collimated.

The radial collimating portion 16 also has a light-emitting face 36, extending generally between the first and second outer axial surfaces 26, 28 and disposed opposite the light-collecting face 30. The shape of the outer light-emitting face 36 is structured to permit light to pass directly through the face 36 and defines the exit opening of the light assembly 10. For example, the outer light-emitting face 36 may have a shape corresponding to an outer perimeter surface of a circular disc, centered about the horizontal axis 18 and transverse to the plurality of radial axes 22.

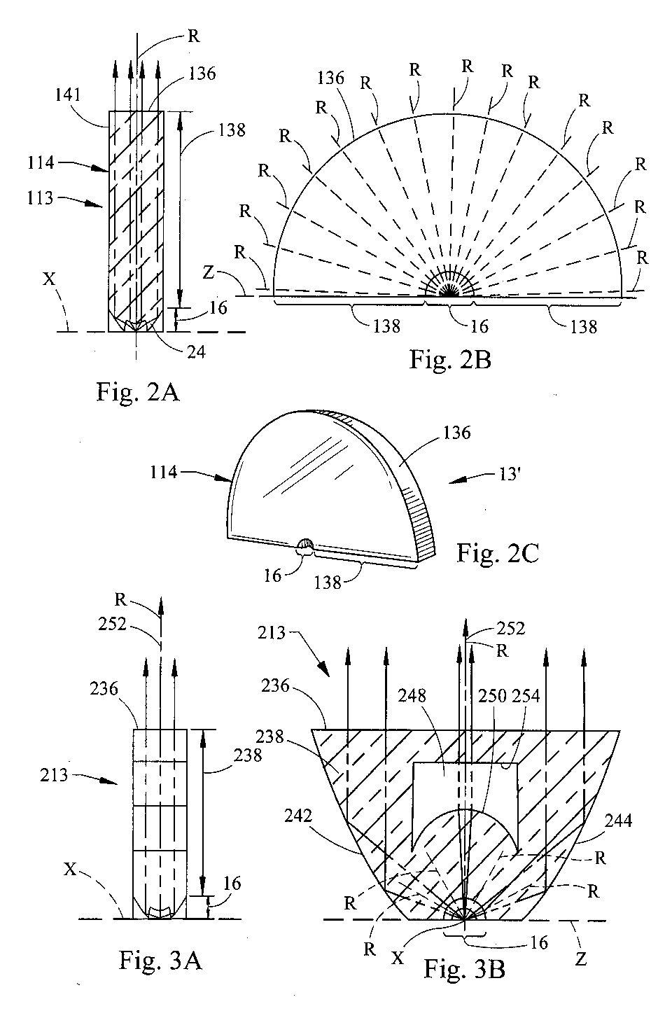

Referring to FIGS. 2A-2C, a main body 114 may further include an extended portion 138 integral with the radial collimating portion 16 and extending outward from the radial collimating portion 16. Light that has been radially directed, that in the Z-R plane, and collimated along each of the X-R planes by the radial collimating portion 16, is received by the extended portion 138. The extended portion 138 extends the main body 114 in a radial direction such that a dimension of the main body 114 along the central axis X is substantially less than a radial dimension along axis Z, to providing the NFL 113 with an exit opening at light-emitting face 136 with a high aspect ratio.

In this embodiment, the main body 114 has a cross-sectional shape (see FIG. 2A) that includes the cross-sectional shape 24 of the radial collimating portion 16 and a rectangular cross-sectional shape 141 of the extended portion 138. The cross-sectional shape 141 is aligned with the cross-sectional shape 24 of the collimating portion 16 so as to maintain collimation of light therethrough. The cross-sectional shape of the main body 114 extends radially outward from the central axis X and the main body 114 has a structure corresponding to a surface of rotation of the cross-sectional shape about the central axis X.

The extended portion 138 directs light towards the light-emitting face 136 while maintaining collimation of light along each of the X-R planes. The face 136 may be shaped and positioned to permit light to pass directly through the face 136 without any significant refraction. For example, the light-emitting face 136 may have a shape corresponding to the outer perimeter surface of a circular disc, centered about the central axis X and transverse to the plurality of radial axes R, so as to minimize refraction of light. Alternatively, the face 136 may be shaped and positioned, for example at an incline to the radial axes 22, to redirect or reflect light angularly relative to the radial axes 22, where light may be permitted to exit through another location of the NFL 113.

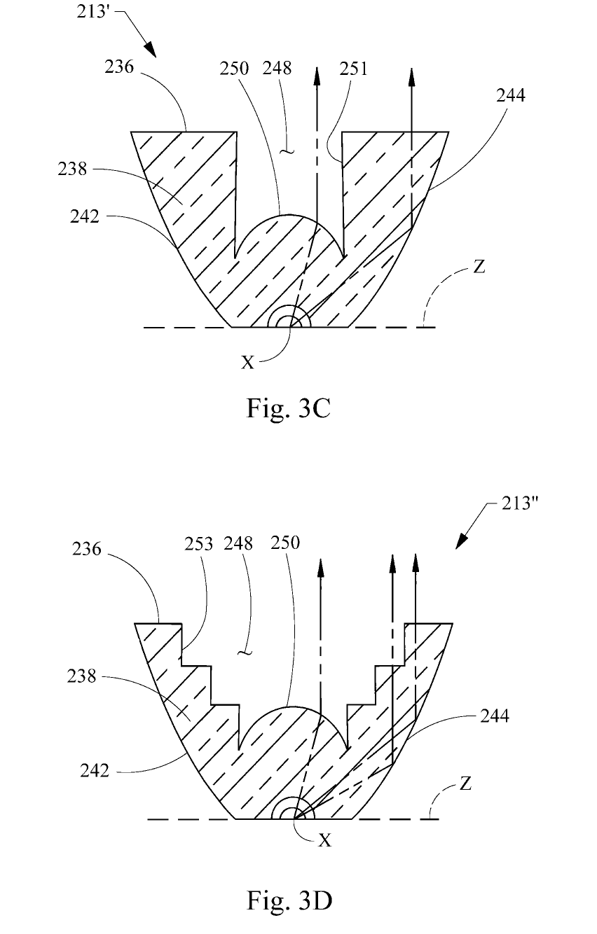

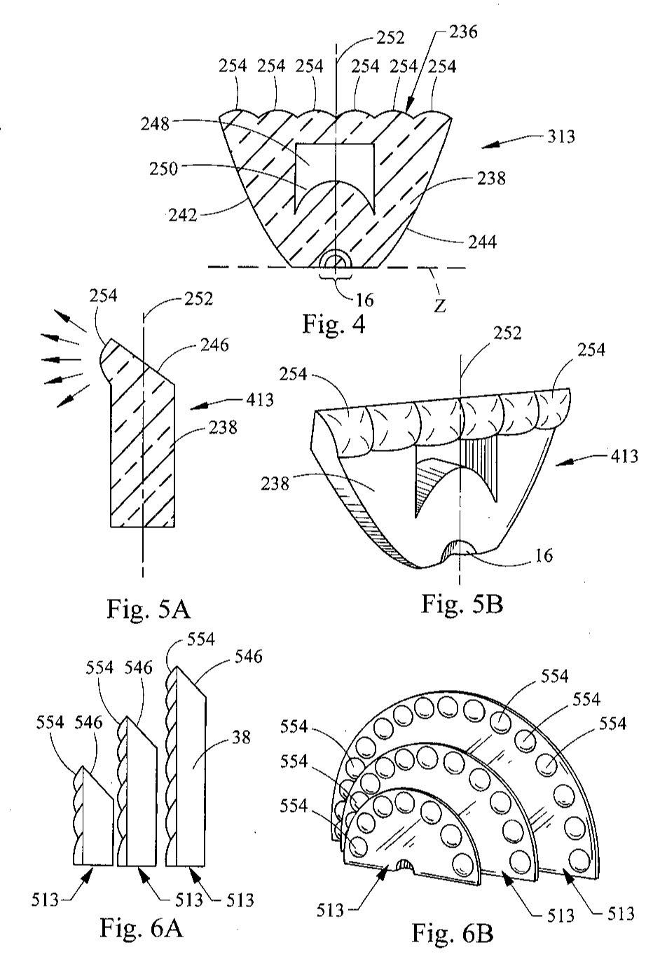

Referring to FIGS. 3A and 3B, in an alternative embodiment NFL 213 is structured to collimate light in both the X-R plane and the Z-R plane. As such, the semi-circular disk shape of the prior embodiment's light-emitting surface 136 is modified to include a planar light-emitting face 236 and side surfaces 242, 244. Additionally, a central opening or open area 248 is formed in the extended portion 238.

The side surfaces 242, 244 are preferably parabolic in shape so as to reflect light directed along the lateral most axes R (via TIR) toward the light emitting face 236 such that the reflected rays are collimated with respect to each other in the Z-R plane parallel to axis 252 and are perpendicular to the light-emitting face 236. At the face 236, the reflected rays are emitted from the NFL 213 without substantial refraction and are therefore substantially collimated.

Light rays along in inner most axes R will not impinge on the side surfaces 242, 244. Rather, these light rays will interact with the central opening 248. The central opening 248 has a collimating face 250 extending along the central axis X. The collimating face 250 is outwardly convex (relative to the central axis X) and shaped to refract and collimate light received along the innermost axes R. The refracted rays then pass through the central opening 248, through a planar and perpendicularly oriented face 254 (cooperating to define the central opening 248), and out of the NFL 213 through the light-emitting face 236. Thus, light exiting the NFL 213 is collimated in two planar.

In another embodiment, shown in FIGS. 3C and 3D, the face 254 of the embodiment of FIG. 3B is removed, together with its projected portion on the light-emitting face 236, so that the collimated light from the collimating surface 250 travels straight without refraction through faces 254 and 236. Thus, the central opening 248 is not enclosed as in the previous embodiment. Such an embodiment also allows for straight side walls 251 (see FIG. 3C) or stepped side walls 253 (see FIG. 3D) in the opening 248, extending between surfaces 236 and 250. The latter operate reduce the wall thickness between the side walls 253 and the surfaces 242 and 244.

As noted above, the light-emitting face 236 is structured to permit light to pass directly there-through and to define an exit opening for an NFL 213. The exit opening defined by face is preferably oriented transverse to the longitudinal axis 252 so as to minimize the refraction of light and may be rectangularly or otherwise shaped.

Referring to FIGS. 4-5B, various other embodiments of an NFL embodying the present invention are illustrated. As seen in FIG. 4, the light-emitting surface 236 of the preceding embodiment may be further formed with pillow shaped optics 254. Such optics 254 are designed to produce a desired emitted beam pattern or spread, as its well known in the art, from the NFL 313. Alternatively, the light-emitting surface 236 may be replaced with an off-normal, incline surface 246 (see FIG. 5A) that is designed to be redirecting light angularly relative to the axis 252, such that light may be permitted to pass laterally out of the NFL 413. As with the preceding embodiment, the exit opening may be provided with pillow shaped optics 254 to spread the beam and rays as desired.

Referring to FIGS. 6A and 6B an alternative embodiment is illustrated which includes a plurality of NFLs 513 according to another aspect of the present invention. The NFLs 513 are matched and/or aligned to create a unique lighting distribution. In the illustrated example, a series of semi-circular, concentrically aligned light patterns, which are more clearly evident from FIG. 6B, are formed. In forming the NFL 513, the NFL 113 of FIGS. 2A-2C is modified to replace the light-emitting surface 136 with a laterally redirecting surface 546. The reflected rays then pass out of the NFL 513 through pillows with circular, rectangular or other geometrical shaped optics 554 located about the perimeter of the NFL 5131 on a side surface of the extended portion 138. The optics 554 are constructed to form a desired beam spread, as is known in the art.

As a person skilled in the art will readily appreciate, the above description is meant as an illustration of implementation of the principles of this invention. This description is not intended to limit the scope or application of this invention and that the invention is susceptible to modification, variation and change, without departing from the spirit of the invention as defined in the following claims.

1. A near field lens for a light assembly having a light source, the lens comprising:
a main body of light transmitting material, the main body having radial collimating portion defined by partial rotation of a cross section about a central axis (X), the radial collimating portion including a light-collecting face and a light-emitting face between opposed outer side surfaces, the light-collecting face including an inner radial surface between opposed inner axial surfaces and cooperating to define a pocket in the main body, wherein the radial collimating portion is structured to direct light radially outward along radial axes (R) from the central axis (X) and to collimate the light in the (X-R) plane.

2. The near field lens according to claim 1 wherein the radial axes (R) and light directed radially therealong substantially corresponds to a light distribution from a Lambertian light source.

3. The near field lens according to claim 1 wherein the inner axial surfaces of the light-collecting face refract light toward the outer side surfaces of the main body and the outer side surfaces collimate and reflect said light toward the light-emitting surface.

4. The near field lens according to claim 1 wherein the inner radial surface of the light-collecting face collimates and refracts light toward the light-emitting face.

5. The near field lens according to claim 4 wherein the inner radial surface is one of conic or free form in axial cross section.

6. The near field lens according to claim 4 wherein the inner radial surface is a convex surface in transverse cross section.

7. The near field lens according to claim 1 wherein the outer side surfaces are one of conic or free form surfaces.

8. The near field lens according to claim 1 wherein the outer side surfaces are outwardly convex parabolic surfaces.

9. The near field lens according to claim 1 wherein the light-emitting face cylindrical and concentric with the central axis (X).

10. The near field lens according to claim 1 wherein the main body is defined by rotation of the cross section about the central axis (X) within a range of up to 180 degrees.

11. The near field lens of claim 1 wherein the main body further includes an extended portion integral with and extending from the light-emitting face of the radial collimating portion.

12. The near field lens of claim 11 wherein the extended portion is rectangular in axial cross section.

13. The near field lens of claim 11 wherein the extended portion is structured to collimate light in a plane perpendicular to the (X-R) plane.

14. The near field lens of claim 11 wherein the extended portion includes an end face disposed between side surfaces, the side surfaces being generally cylindrical about the central axis (X).

15. The near field lens of claim 11 wherein the end face of the extended portion is planar.

16. The near field lens of claim 11 wherein the end face of the extended portion is structured to pass light directly there through.

17. The near field lens of claim 11 wherein the end face is angularly oriented to reflect light rays out of the lens in a direction generally along the central axis (X).

18. The near field lens of claim 11 further comprising a central open area within the main body, the central open area being partially defined by a collimating radial surface and side walls on opposing sides of the collimating surface.

19. The near field lens of claim 18 wherein the central open area is enclosed by the main body.

20. The near field lens of claim 18 wherein the side walls are stepped side walls.

21. The near field lens of claim 1 wherein the lens is of a thin plate shape, having a thickness defined along the central axis (X) that is substantially less than a length defined transverse to the central axis (X).

22. The near field lens of claim 1 in combination with a LED light source.
